(19) United States
(12) Patent Application Publication
(10) Pub. No.: US 2026/0155478 A1
(43) Pub. Date: Jun. 4, 2026

(54) THERMAL COMPONENTS FOR MULTI-SIDED THERMAL REGULATION OF BATTERIES

(71) Applicant: Rivian IP Holdings, LLC, Irvine, CA (US)

(72) Inventors: Youngbin LIM, Irvine, CA (US); Jonathan VERGHESE, Costa Mesa, CA (US); Sunoj Cherian GEORGE, Irvine, CA (US); Jeffrey Michael ALVES, Pleasanton, CA (US); Baojin WANG, San Marcos, CA (US); Xingyu REN, Irvine, CA (US); Deepak PITROLA, Irvine, CA (US); Casey Taylor DUNN, Mission Viejo, CA (US)

(21) Appl. No.: 19/352,453

(22) Filed: Oct. 7, 2025

Related U.S. Application Data
(60) Provisional application No. 63/727,516, filed on Dec. 3, 2024.

(51) Int. Cl. H01M 10/6556; B60K 1/04; B60L 50/64; B60L 58/26; B60L 58/27; H01M 10/42; H01M 10/613; H01M 10/615; H01M 10/625; H01M 10/63; H01M 10/643; H01M 10/647; H01M 10/656; H01M 10/658; H01M 50/209; H01M 50/213; H01M 50/249; H01M 50/271

(52) U.S. Cl. CPC H01M 10/6556; B60K 1/04; B60L 50/64; B60L 58/26; B60L 58/27; H01M 10/425; H01M 10/613; H01M 10/615; H01M 10/625; H01M 10/63; H01M 10/643; H01M 10/647; H01M 10/656; H01M 10/658; H01M 50/209; H01M 50/213; H01M 50/249; H01M 50/271; B60K 2001/0438; H01M 2010/4271; H01M 2220/20

(57) ABSTRACT

Multiple thermal components for thermal regulation of batteries is provided. An electric vehicle can include a first thermal component configured to provide a thermal management function to a first side of a plurality of battery subassemblies. The electric vehicle also includes a plurality of second thermal components with each configured to provide the thermal management function to a second side of the plurality of battery subassemblies that opposes the first side. The first thermal component circulates a fluid through the first thermal component along a first axis and distributes the fluid along a second axis orthogonal to the first axis to each of the second thermal components through a cross member located between respective ones of the plurality of second thermal components. The first thermal component can form a lid for a battery pack and may function as a structural element to serve as a floor of the electric vehicle.

### CROSS-REFERENCE TO RELATED APPLICATIONS

The present application claims the benefit of U.S. Provisional Application No. 63/727,516, entitled “MULTI-SIDED COOLING PLATES FOR THERMAL REGULATION OF BATTERIES”, filed Dec. 3, 2024, the entirety of which is incorporated herein for reference.

### INTRODUCTION

Batteries are often used as a source of power, including as a source of power for electric vehicles that include wheels that are driven by an electric motor that receives power from a battery. Aspects of the subject technology can help to improve the efficiency and/or range of electric vehicles, which can help to mitigate climate change by reducing greenhouse gas emissions.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery subassemblies that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a block diagram of a dual top and bottom thermal component architecture in accordance with one or more implementations.

FIG. 4A illustrates a block diagram of a top view of the thermal management system in accordance with one or more implementations.

FIG. 4B illustrates a block diagram of a side view of the thermal management system in accordance with one or more implementations.

FIG. 5 is a flow chart of illustrative operations that may be performed for thermal regulation of batteries using multiple thermal components in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. Structures and components are shown in block diagram form in order to avoid obscuring the concepts of the subject technology.

Battery packs may include cylindrical cells or prismatic cells. Battery packs with cylindrical cells may include a configuration that consists of a sandwiched, double-stack module with a single thermal component located between the double-stack module. While this arrangement can provide thermal management in battery packs, achieving faster charging times can be beneficial to address challenges in thermal management. Specifically, for both prismatic cells and cylindrical cells, it can be advantageous to expose cell interfaces more directly to the surrounding thermal management system to enhance thermal performance such as cooling efficiency and heat generation reduction. Battery packs may combine prismatic cells to maximize cooling system interface coverage on battery cell sides.

Embodiments of the subject technology provide for a thermal management system containing both top and bottom thermal components for thermal management of battery packs, enhancing the overall thermal regulation, structural integrity, and space efficiency of battery packs for electric vehicles. The subject technology can provide improved direct current fast-charging (DCFC) times and enhance thermal management, specifically for high-performance applications and demanding duty cycles. Battery packs with prismatic cells may include a configuration that includes a dual top and bottom thermal component architecture for the battery cell and battery pack structure, improving cooling efficiency and thermal management capabilities. The dual top and bottom thermal component architecture can address DCFC performance and accommodate high-performance, thermally demanding duty cycles typical of vehicle use cases, including scenarios such as steep-gradient operations under elevated ambient temperatures. Enhanced battery cooling under such conditions facilitates performance stability during varying duty cycles encountered by vehicles.

Integration of the thermal management system with the vehicle structure reduces spatial requirements and increases structural rigidity. The dual top and bottom thermal component architecture includes a top thermal component and a bottom thermal component. The top thermal component, which can additionally serve as a battery pack lid, has increased thickness to provide added structural support. The bottom thermal component can optimize fluid flow to minimize cell-to-cell temperature variation within the battery pack. The subject technology also provides for enhancements in manufacturing process efficiencies, and the integration of the thermal management system with high-voltage distribution networks and electronic control modules.

The subject technology can provide several advantages over other thermal management techniques. For example, utilizing both top and bottom thermal components of the subject technology can provide effective thermal management by facilitating heat dissipation occurring from both sides of the battery cells (e.g., both top and bottom sides of the battery cells). This architecture can help distribute thermal load more evenly, increasing the efficiency of heat rejection during high-load operations, such as charging and discharging cycles, and reducing the risk of thermal hotspots that can compromise performance and safety.

In one or more implementations, a thermal component may include or be formed as a thermal management component to regulate thermal properties of surrounding or adjacent components by providing a thermal management function to such components. A thermal management function can refer to an operational capability of a thermal component to control heat transfer by removing, distributing, or supplying thermal energy to maintain adjacent components within a defined temperature range. In one or more implementations, the thermal component may include or be formed as a thermal plate to provide thermal management functions such as cooling or heating to adjacent components such as a battery subassembly. The thermal plate may be a monolithic structure or a modular structure. In one or more other implementations, the thermal component may include or be formed as one or more tubes configured to carry a fluid to provide thermal management functions such as cooling or heating to nearby components.

The top thermal component can function not only as a thermal management component but also as a structural element. The top thermal component can act as a lid or a portion of the vehicle's floor, enhancing mechanical strength and potentially offering impact resistance. The bottom thermal component may contribute to structural integrity by interacting with cross members in a modular configuration, reducing deformation and providing added support during external impacts. For example, the top thermal component may be thicker to provide structural support and withstand external forces, while the bottom thermal component can be optimized for thermal transfer without compromising the structural requirements.

The use of separate, modular bottom thermal components can facilitate scalability for different battery pack configurations and layouts. This modularity may allow for flexibility in battery pack design, accommodating different numbers of battery cells, module arrangements, and cooling needs. This modularity of the bottom thermal component may simplify assembly and integration within various vehicle platforms.

The dual top and bottom thermal component architecture can help reduce the need for air gaps between the battery pack, vehicle floor, and battery cells, freeing up space that can be used for additional battery cells or other electrical components. The dual top and bottom thermal component architecture also helps increase thermal insulation and reduce thermal gradients across the battery pack, leading to more efficient and stable temperature regulation of the battery pack.

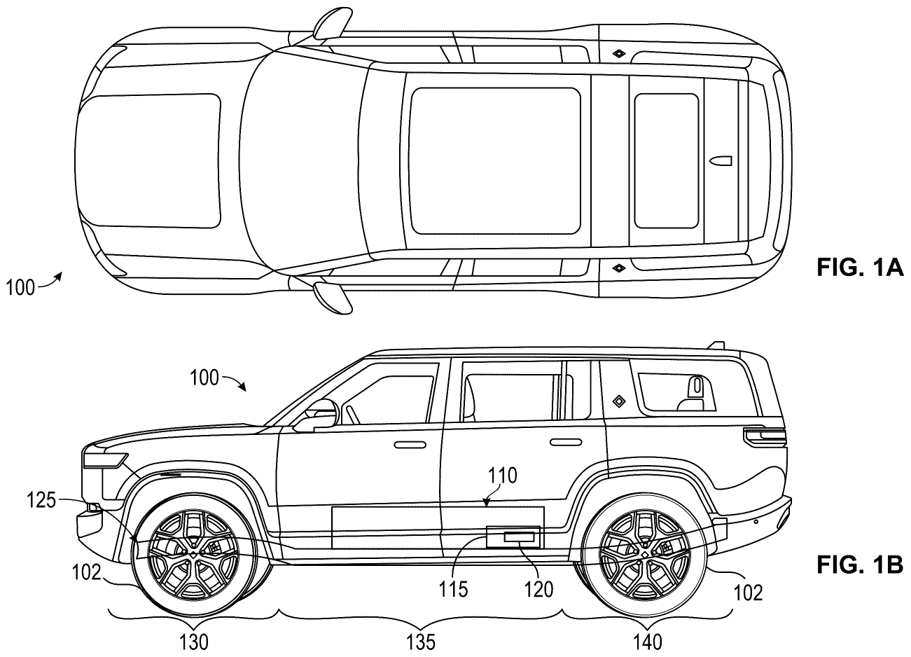

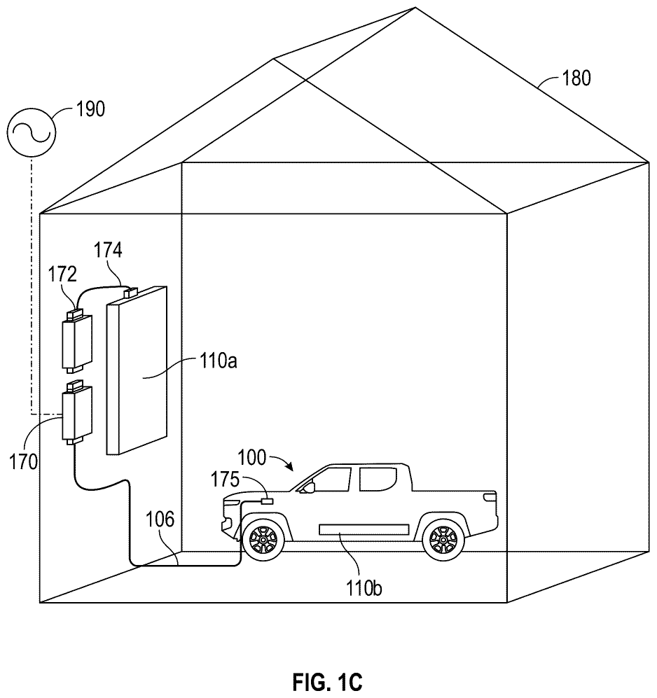

FIG. 1A is a diagram illustrating an example implementation of an apparatus as described herein. In the example of FIG. 1A, the apparatus is a moveable apparatus implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a sport utility vehicle (SUV) (e.g., an electric sport utility vehicle) having a battery pack 110. As shown, the battery pack 110 may include one or more battery subassemblies 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery subassemblies 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery subassembly 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery subassembly 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into alternating current (AC) power for one or more components and/or systems of the vehicle (e.g., including one or more power outlets of the vehicle). The power stage circuit can be provided as part of the battery pack 110 or separately from the battery pack 110 within the vehicle 100.

As shown in FIG. 1B, vehicle 100 may include a support structure such as a chassis 125 (e.g., a frame, internal frame, or other support structure). The chassis 125 may support various components of the vehicle 100. As shown, the chassis 125 may span a front portion 130 (e.g., a hood or bonnet portion), center body portion 135, and a rear portion 140 (e.g., a trunk, payload, or boot portion) of the vehicle 100 in some implementations. In one or more implementations, battery pack 110 may be installed on the chassis 125 (e.g., within one or more of the front portions 130, center body portion 135, or the rear portion 140). In one or more other implementations, battery pack 110 may include or be electrically coupled with one or more one busbars (e.g., one or more current collector elements), of which may include electrically conductive material to connect or otherwise electrically couple battery subassembly 115 or the battery cell(s) 120 with other electrical components of vehicle 100 to provide electrical power to various systems or components of vehicle 100.

In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as an electric truck, another type of electric SUV, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery subassemblies 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 175 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

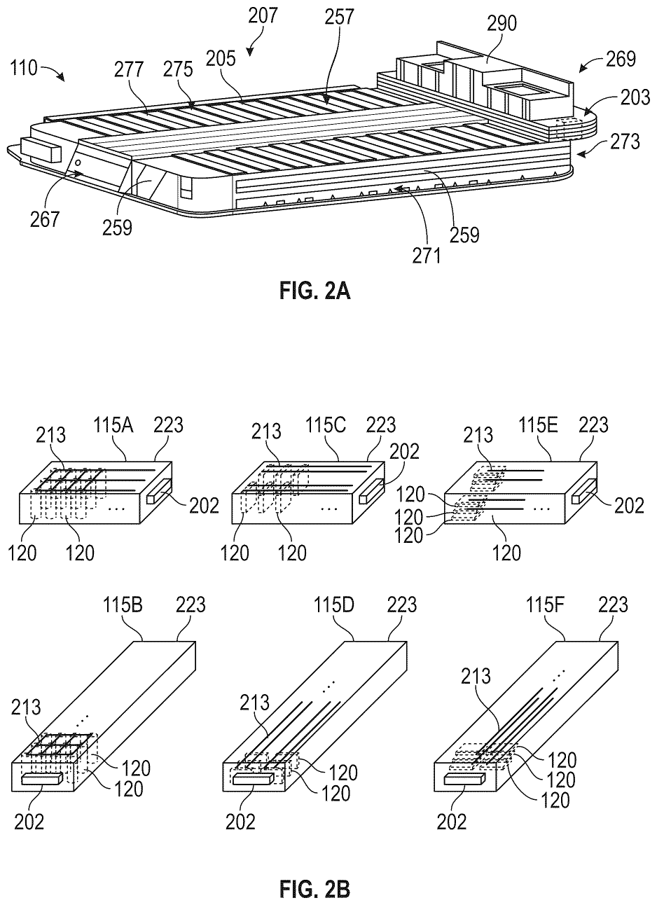

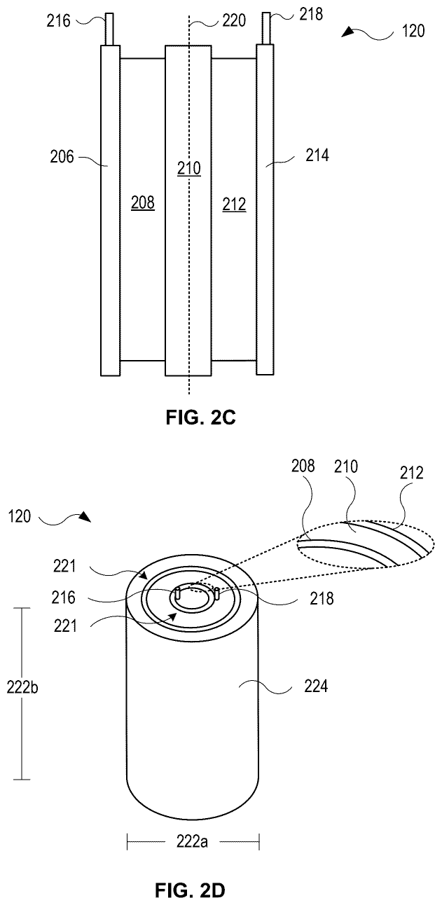

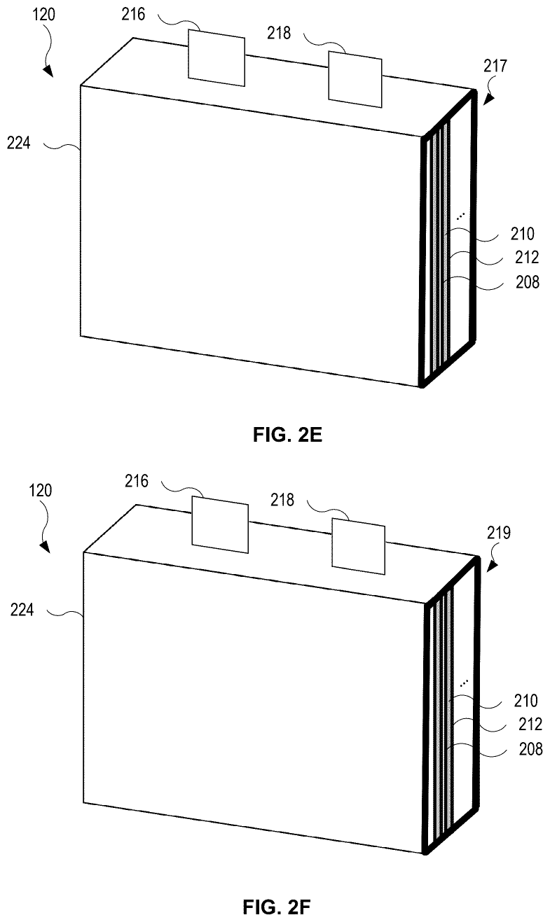

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery subassemblies 115 and/or one or more battery cells 120, and/or other battery pack components. In one or more implementations, the energy volume enclosure 205 may include or form a shielding structure on an outer surface thereof (e.g., a bottom thereof and/or underneath one or more battery subassembly 115, battery units, batteries, and/or battery cells 120) to protect the battery subassembly 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.). In one or more other implementations, the battery subassembly 115 may include or be formed as a battery module.

Battery pack 110 may include, within the energy volume 207 and the energy volume enclosure 205, multiple battery cells 120 (e.g., directly installed within the battery pack 110, or within batteries, battery units, battery subassemblies 115, and/or battery modules as described herein) and/or battery subassemblies 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery subassemblies 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more other implementations, the modular electrical component assembly 290 may be arranged on the same plane (or in-plane) with the energy volume enclosure 205 such that the modular electrical component assembly 290 and the energy volume enclosure 205 are positioned side-by-side with one another. In one or more implementations, the modular electrical component assembly 290 may include one or more of the conductive coupling elements for routing power from the battery cells 120 and/or battery subassemblies 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations.

In one or more implementations, the modular electrical component assembly 290 may include a high-voltage distribution box (HVDB) and/or an energy management module (EMM). In one or more other implementations, the modular electrical component assembly 290 houses the HVDB and omits the EMM such that the EMM is housed in a separate assembly mounted to or arranged in-plane with the energy volume enclosure 205. In one or more other implementations, the modular electrical component assembly 290 houses the EMM and omits the HVDB such that the HVDB is housed in a separate assembly mounted to or arranged in-plane with the energy volume enclosure 205.

In one or more implementations, the HVDB is a component in electric vehicles that manages and distributes high-voltage electrical power from the battery to various systems and components within the vehicle. It can ensure the safe and efficient distribution of power, often incorporating safety features such as fuses and relays to protect the vehicle's electrical system. The HVDB can include functionality for distributing high voltage power from the battery pack 110 to various systems within the vehicle 100, facilitating efficient power management and safety by regulating and directing electrical flow to components such as the drive unit, charging system, and auxiliary systems. The HVDB can be configured as a modular and pack-agnostic component that interfaces with battery packs of varying structural and chemical configurations. It can be independently designed and manufactured, allowing it to attach externally to the battery pack 110. The integration of the HVDB is facilitated through standardized electrical and thermal connectors that are positioned at consistent locations across different battery pack designs. This uniformity supports the coupling of the HVDB with various battery packs, streamlining manufacturing processes, inventory management, and service operations.

In one or more other implementations, the EMM is a system or device that can optimize the use and distribution of energy within electric vehicle. It can monitor energy consumption, manage power distribution, and ensure efficient operation by controlling various components to reduce energy waste and improve overall performance. The EMM can be configured to optimize the use and distribution of energy within the vehicle 100 by managing energy flow between the battery pack 110, drive unit, and other electrical systems, ensuring efficient energy usage and enhancing overall vehicle performance. The EMM also can be configured to manage energy demands, improving battery life, and supporting vehicle functionalities like regenerative braking and power management during different driving conditions. In one or more other implementations, the EMM can interface with the battery pack 110 through standardized connectors, enabling it to function across different battery pack designs. The EMM can be similarly configured as a universal component compatible with various battery pack configurations. The EMM may be responsible for monitoring and controlling operational parameters of the battery pack 110. The EMM may be a collection of electronic, power, magnetic, and/or cooling components housed within the EMM. Example components of the EMM may include cooling fluid, a fluid flow path, a controller, a direct current to direct current (DC-DC) converter, an alternating current to direct current (AC-DC) converter, and a direct current to alternating current (DC-AC) converter, a printed circuit board (PCB), a connector, a relay, or the like.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery subassemblies 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery subassemblies 115 and/or battery cells 120 disposed within the energy volume enclosure 205. For example, a thermal component may be positioned in contact with one or more battery subassemblies 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery subassemblies and/or battery cells in the battery pack 110.

As shown, the energy volume enclosure 205 of the battery pack 110 may include a lid 277. For example, the lid 277 may cover and extend over one or more battery subassemblies 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery subassemblies 115, battery cells 120, and/or other battery subassemblies within the energy volume enclosure 205 (e.g., within a space defined by the top 257 and the sidewalls 259 of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery subassemblies 115, battery cells 120, and/or other battery subassemblies within the energy volume enclosure 205.

FIG. 2B depicts various examples of battery subassemblies 115 that may be disposed in the battery pack 110 (e.g., within the energy volume enclosure 205 of FIG. 2A). In the example of FIG. 2B, a battery subassembly 115A is shown that includes a battery module housing 223 having a rectangular cuboid shape with a length that is substantially similar to its width. In this example, the battery subassembly 115A includes multiple battery cells 120 implemented as cylindrical battery cells. In this example, the battery subassembly 115A includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery subassembly 115A may include a charge collector or busbar 202. For example, the busbar 202 may be electrically coupled to the interconnect structure 213 to collect the charge generated by the battery cells 120 to provide a high voltage output from the battery subassembly 115A.

FIG. 2B also shows a battery subassembly 115B having an elongate shape, in which the length of the battery module housing 223 (e.g., extending along a direction from a front end of the battery pack 110 to a rear end of the battery pack 110 when the battery subassembly 115B is installed in the battery pack 110) is substantially greater than a width (e.g., in a transverse direction to the direction from the front end of the battery pack 110 to the rear end of the battery pack 110 when the battery subassembly 115B is installed in the battery pack 110) of the battery module housing 223. For example, one or more battery subassemblies 115B may span the entire front-to-back length of a battery pack within the energy volume enclosure 205. As shown, the battery subassembly 115B may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115B.

In the implementations of battery subassembly 115A and battery subassembly 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery subassembly 115C having a battery module housing 223 having a rectangular cuboid shape with a length that is substantially similar to its width and including multiple battery cells 120 implemented as prismatic battery cells. In this example, the battery subassembly 115C includes rows and columns of prismatic battery cells that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery subassembly 115C may include a charge collector or busbar 202. For example, the busbar 202 may be electrically coupled to the interconnect structure 213 to collect the charge generated by the battery cells 120 to provide a high voltage output from the battery subassembly 115C.

FIG. 2B also shows a battery subassembly 115D including prismatic battery cells and having an elongate shape, in which the length of the battery module housing 223 (e.g., extending along a direction from a front end of the battery pack 110 to a rear end of the battery pack 110 when the battery subassembly 115D is installed in the battery pack 110) is substantially greater than a width (e.g., in a transverse direction to the direction from the front end of the battery pack 110 to the rear end of the battery pack 110 when the battery subassembly 115D is installed in the battery pack 110) of the battery module housing 223. For example, one or more battery subassemblies 115D having prismatic battery cells may span the entire front-to-back length of a battery pack within the energy volume enclosure 205. As shown, the battery subassembly 115D may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115D.

As another example, FIG. 2B also shows a battery subassembly 115E having a battery module housing 223 having a rectangular cuboid shape with a length that is substantially similar to its width and including multiple battery cells 120 implemented as pouch battery cells. In this example, the battery subassembly 115C includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery subassembly 115E may include a charge collector or busbar 202. For example, the busbar 202 may be electrically coupled to the interconnect structure 213 to collect the charge generated by the battery cells 120 to provide a high voltage output from the battery subassembly 115E.

FIG. 2B also shows a battery subassembly 115F including pouch battery cells and having an elongate shape in which the length of the battery module housing 223 (e.g., extending along a direction from a front end of the battery pack 110 to a rear end of the battery pack 110 when the battery subassembly 115E is installed in the battery pack 110) is substantially greater than a width (e.g., in a transverse direction to the direction from the front end of the battery pack 110 to the rear end of the battery pack 110 when the battery subassembly 115E is installed in the battery pack 110) of the battery module housing 223. For example, one or more battery subassemblies 115E having pouch battery cells may span the entire front-to-back length of a battery pack within the energy volume enclosure 205. As shown, the battery subassembly 115E may also include a busbar 202 electrically coupled to the interconnect structure 213. For example, the busbar 202 may be electrically coupled to the interconnect structure 213 to collect the charge generated by the battery cells 120 to provide a high voltage output from the battery subassembly 115E.

In various implementations, a battery pack 110 may be provided with one or more of any of the battery subassemblies 115A, 115B, 115C, 115D, 115E, and 115F. In one or more other implementations, a battery pack 110 may be provided without battery subassemblies 115 (e.g., in a cell-to-pack implementation). In one or more implementations, a battery pack 110 may be provided with three elongated battery subassemblies (e.g., three of battery subassemblies 115B, 115D, and/or 115F).

In one or more implementations, multiple battery subassemblies 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery subassemblies 115. For example, the battery pack 110 may have a cell-to-pack configuration in which battery cells 120 are arranged directly into the battery pack 110 without assembly into a battery subassembly 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium-ion battery cell in which the anode 208 is formed from a carbonaceous material (e.g., graphite or silicon-carbon). In these implementations, lithium-ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium-ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212 and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, the battery cell 120 can include an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a busbar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

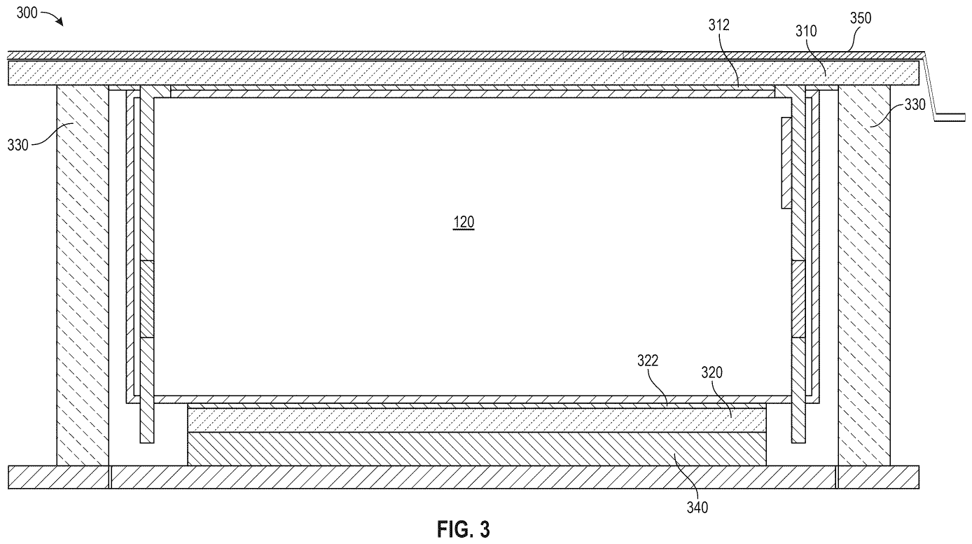

FIG. 3 illustrates a block diagram of a thermal system architecture 300 in accordance with one or more implementations. In one or more implementations, the thermal system architecture 300 may include two different arrangements. Both arrangements may incorporate dual-sided cooling to increase the total surface area of battery cell contact, improving the rate of heat removal from the battery pack 110. For example, a first arrangement may utilize a modular thermal component configuration in which each battery subassembly 115 can incorporate a dedicated top thermal component or bottom thermal component, while a second arrangement may employ a larger thermal component configured for battery pack level cooling, or a combination thereof. Modularity may allow omission of one thermal component in lower-performance applications.

As illustrated in FIG. 3, the thermal system architecture 300 includes a top thermal component 310 arranged on a top side of a battery cell 120 (or a battery subassembly 115). The top thermal component 310 may be configured as a single component capable of cooling multiple battery subassemblies 115 simultaneously and may also integrate additional functions such as sealing and mechanical closure of a back lid. The thermal system architecture 300 also includes a bottom thermal component 320 arranged on a bottom side of the battery cell 120 (or the battery subassembly 115). In one or more implementations, the thermal system architecture 300 may employ a large top thermal component 310 and multiple bottom thermal component 320 components spanning multiple battery subassemblies 115, potentially integrating additional functions such as a top lid and thermal management sides into a single assembly to simplify manufacturing and installation. In one or more other implementations, the thermal system architecture 300 may utilize multiple smaller, subassembly-level thermal components as both the top thermal component 310 and bottom thermal component 320, supporting modular installation and potentially differing maintenance procedures.

In one or more other implementations, the thermal system architecture 300 may be configured to vary the number of thermal components employed depending on the cost and performance parameters of a target vehicle platform. For example, the thermal system architecture 300 may omit one of the top thermal component 310 or the bottom thermal component 320. For vehicle platforms positioned in lower cost categories, a single thermal component may be utilized to reduce component cost and to reduce the overall capacity of the thermal system architecture 300. In such configurations, thermal attributes such as charging duration and other thermally constrained operating cases may exhibit reduced performance metrics, which aligns with the design tradeoffs associated with lower cost vehicles. For vehicle platforms positioned in higher cost categories, two or more thermal components may be employed to increase thermal system capacity and to provide improved thermal attributes, including reduced charging duration and improved management of thermally limited operating cases. In this manner, the thermal system architecture 300 can provide flexibility to support a range of vehicle price points by selectively including or excluding a second thermal component independent of substantial redesign of the overall assembly.

The top thermal component 310 and/or the bottom thermal component 320 can be directly bonded onto the battery cell 120 (or battery subassembly 115). In one or more implementations, each of the top thermal component 310 and the bottom thermal component 320 includes a thermally conductive material. Both top and bottom cooling configurations are operational concurrently. The thermal system architecture 300 can function continuously without electronic actuation of top or bottom cooling configurations, meaning a vehicle control system may not be used to selectively activate these configurations. For example, both the top thermal component 310 and bottom thermal components 320 are configured with continuous operation, independent of charging state or other battery conditions.

In one or more other implementations, the thermal system architecture 300 can operate based on various vehicle states to provide thermal management. In this regard, the top thermal component 310 and the bottom thermal components 320 may provide active cooling based on specific vehicle states. For example, operational modes of the vehicle 100 can be used to selectively engage certain cooling pathways to achieve thermal efficiency during high-load conditions. During high thermal load states such as charging, effective cooling can be beneficial to manage thermal propagation. In one or more other implementations, the thermal system architecture 300 may include directional control valves within y-direction cross members 330, enabling selective activation of the top thermal component 310 or the bottom thermal components 320 based on specific vehicle modes.

Some thermal management systems utilize a separate top lid on top of the battery cell 120 to accommodate cell venting channels. Other thermal management systems may include an air gap between a vehicle floor 350 and a battery pack lid including the presence of a thermal regulating tube atop the pad beneath the vehicle floor 350. The thermal system architecture 300 can optimize the available space by reducing the need for an additional battery pack top lid, instead reinforcing the top thermal component 310 by increasing its thickness. For example, the top thermal component 310 optimized solely for thermal performance may utilize a minimum thickness of about 0.8 mm. In one or more other implementations, to serve as both a thermal component and structural element, the thickness of the top thermal component 310 may be increased to about 1 mm. The top thermal component 310 functioning as a structural element to serve as a lid can reduce the need for vent channels between the battery pack 110 top lid and the battery cell 120 due to cell venting in the y-direction, as illustrated in FIG. 3. Since the top thermal component 310, constructed of a rigid metal such as aluminum, can be directly bonded with the battery cells 120, the top thermal component 310 can exhibit increased heat dissipation at low temperatures. To mitigate this, a thermal insulation material can be disposed onto a top side of the top thermal component 310, enhancing isolation and reducing heat loss, thus reducing internal air gaps in the battery pack 110 and between the vehicle floor 350 and the battery pack 110. The top thermal component 310 may integrate with a thermal insulation layer 312 as a unified lid. In one or more implementations, the thermal insulation layer 312 can be mechanically coupled to the top thermal component 310 by an adhesive material. The thermal insulation layer 312 may also resist relative lateral displacement between adjacent components of the battery assembly that arises from inertial forces during vehicle acceleration, deceleration, or impact events. The thermal insulation layer 312 may function as a structural element to provide structural support for shear loads. For example, the thermal insulation layer 312 may accommodate shear stresses generated by differential thermal expansion between the battery cells 120 and adjoining structural or thermal regulation elements. In one or more other implementations, a thermal insulation layer 322 can be interposed between the bottom side of the battery cell 120 (or the battery subassembly 115) and the bottom thermal component 320. The thermal insulation layer 322 can be mechanically coupled to the bottom thermal component 320 by an adhesive material. In one or more implementations, an energy absorbing material 340 may be disposed onto a bottom side of the bottom thermal component 320 such that the energy absorbing material 340 provides additional structural integrity to the bottom thermal component 320.

The top thermal component 310 and the bottom thermal components 320 can differ in dimensions based on functional requirements. For example, the top thermal component 310, serving as a structural element as the battery pack 110 top lid and the vehicle floor 350, can have a greater thickness compared to the bottom thermal component 320. For example, the top thermal component 310 may have a thickness of about 5 mm and the bottom thermal component 320 may have a thickness of about 4 mm.

The top thermal component 310 may include additional structural features, such as structural reinforcements or impact mitigation measures for durability against potential external loads (e.g., heavy objects dropped on the vehicle floor 350). The application of thermal insulation and noise, vibration, and harshness (NVH) pads provides additional structural integrity and thermal protection to the top thermal component 310, increasing its overall thickness (e.g., by approximately 10 mm) for enhanced robustness and rigidity.

In one or more implementations, the battery pack 110 can retain a robust thermal component structure along the battery module length, even when a middle section of the battery pack 110 is cut out. The thermal system architecture 300 may allow either of the top thermal component 310 or the bottom thermal components 320 to function as structural members for the battery subassembly 115, reducing the need for an additional encapsulating layer around the battery cells 120. The battery cells 120 can be directly assembled onto the bottom thermal component 320, and the top thermal component 310 can provide beneficial compression and structural support during battery pack assembly, enhancing manufacturing efficiency and integration.

In one or more implementations, configurations of the thermal system architecture 300 may include a shear plate with integrated vents in lieu of the bottom thermal component 320 to maintain structural and venting functionality. When both the top thermal component 310 and the bottom thermal component 320 are present, the bottom thermal component 320 may also function as the shear plate, providing combined thermal and structural performance. The bottom thermal component 320 configuration may be implemented on a per-battery subassembly 115 basis, with each battery subassembly 115 incorporating its own bottom thermal component 320 assembly. The bottom thermal component 320 may also serve as a thermal insulation layer 322, with the venting architecture configured to manage thermal runaway events by directing ejecta and preventing particulate, gas, or debris from re-entering sensitive areas such as electrical terminals. The bottom thermal component 320 may incorporate thermal protection features to reduce the likelihood of battery cell failures. These venting protection features may be specific to the bottom thermal component 320, as vent locations may be positioned at the lower portion of the battery pack 110.

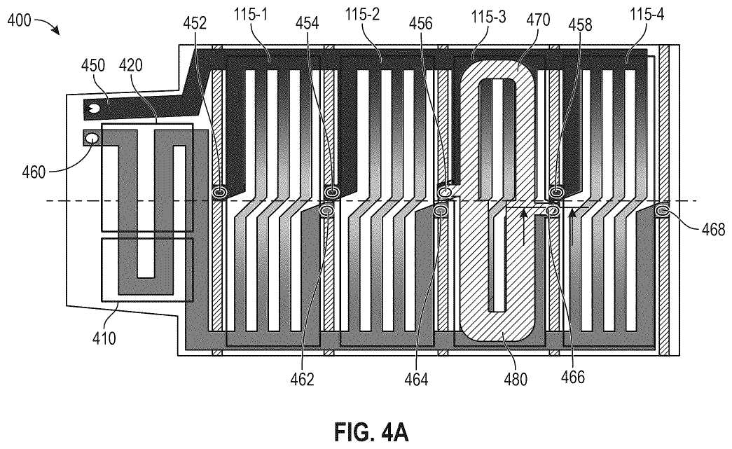

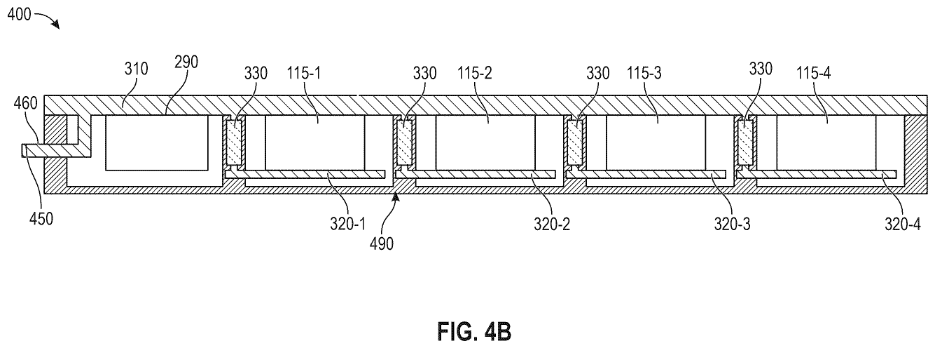

Blind-mate cooling interfaces may be incorporated at each end plate of the battery subassembly 115, allowing thermal line connections to be made vertically irrespective of precise manual positioning. In one or more implementations, a carrier structure (not shown) may be coupled to one of the top thermal component 310 or the bottom thermal component 320, with the opposing thermal component installed in a manner that allows inlet (e.g., inlet 450 of FIGS. 4A and 4B) and outlet (e.g., outlet 460 of FIGS. 4A and 4B) ports to blind-mate into corresponding fittings. Both thermal flow architectures may employ an out-and-back circulation channel design, resulting in the module manifold assembly 530 being located adjacent to one end plate 510 at one end of the battery subassembly 115. The opposite end may contain the battery monitoring circuit 570 and opposing end plate 510. Spring tab features may be integrated into female fittings to facilitate self-alignment during blind-mate engagement. These fittings may employ a conical lead-in geometry and spring retention elements to allow limited multi-directional movement, aiding in centering and engagement. The spring tabs may be integrated into a bracket assembly supporting the fittings.

FIG. 4A illustrates a block diagram of a top view of a thermal management system 400 in accordance with one or more implementations. In one or more implementations, during assembly, one of the top thermal component 310 or bottom thermal component 320 can be secured to the battery cell 120 structure, while the other thermal component can be aligned and installed in a manner that may be performed as a blind-mate operation, minimizing manual positioning relative to inlet 450 and outlet 460. In one or more implementations, the thermal management system 400 may route fluid across the width of the vehicle 100. In one or more other implementations, the thermal management system 400 may route fluid along the length of the vehicle 100.

The thermal management system 400 can integrate a top thermal component 310 and bottom thermal components 320 with parallel flow configurations. In one or more implementations, the fluid flow architecture utilizes parallel flow paths to all four battery subassemblies 115, with designated inlet 450 and outlet 460 ports. The top thermal component 310 may employ a direct out-and-back first circulation channel 470, while the bottom thermal component 320 may include a similar out-and-back second circulation channel 480 with vented sections positioned to avoid routing fluid through certain regions at the bottom of the battery cells 120. The circulation channel layouts between the top thermal component 310 and the bottom thermal component 320 may differ to optimize the thermal management system 400 performance and prevent undesired thermal exposure in specific areas.

The thermal management system 400 involves connecting both the top thermal component 310 and bottom thermal components 320 while minimizing space used for fluid routing. A fluid may flow beginning at the top thermal component 310. The fluid may circulate horizontally through a circulation channel across the top thermal component 310, interacting with the y-direction cross members 330 that house rigid channels bridging fluid pathways between the top thermal component 310 and bottom thermal components 320. In this configuration, the vertical thermal piping can transition the fluid to the bottom thermal component 320. In one or more implementations, the fluid may be supplied through the inlet 450 that may branch into separate parallel flow paths for the top thermal component 310 and the bottom thermal component 320, with each plate operating independently. The outlet flow may be recombined into a single return path via the outlet 460. In configurations where the bottom thermal component 320 is omitted, the branch connection may be blocked to direct fluid through the top thermal component 310.

The modular electrical component assembly 290 also incorporates functionality for integrating the thermal management system 400 used for battery cells 120 with other electronic components of the battery pack 110. Specifically, the top thermal component 310, which provides thermal regulation for the battery cells 120, can be thermally coupled to the modular electrical component assembly 290. For example, the top thermal component 310 may provide a thermal management function (e.g., cooling or heating) to a side of the modular electrical component assembly 290, such as in-plane with the modular electrical component assembly 290. This configuration allows for a unified thermal regulation system that manages thermal conditions within the battery cells 120 and electronic systems housed within the modular electrical component assembly 290.

The integration of the modular electrical component assembly 290 with the top and bottom thermal components 310 and 320 facilitates that electronic components housed within the modular electrical component assembly 290 are maintained within optimal thermal conditions. By integrating the thermal management system 400 across the battery cells 120 and the modular electrical component assembly 290, the battery pack 110 can achieve a streamlined design that simplifies the design and maintenance of battery systems in applications such as electric vehicles. For example, the top thermal component 310 can be thermally coupled to the battery subassemblies 115 and the modular electrical component assembly 290 to provide thermal regulation within each of the battery subassemblies 115 and the modular electrical component assembly 290.

The battery pack 110 may include four battery subassemblies (e.g., 115-1, 115-2, 115-3, 115-4), with each battery subassembly 115 with a dedicated thermal component (e.g., 320-1, 320-2, 320-3, 320-4) at a bottom side of the battery subassembly 115. The fluid may enter each bottom thermal component 320 through designated inlets (e.g., 452, 454, 456, 458), circulate horizontally through a diameter-varying circulation channel (e.g., 470, 480) across the bottom thermal component 320, and fed back upward through another vertical piping section feeding into a common outlet 460. This configuration can establish parallel pathways, allowing fluid circulation from top to bottom and vice versa.

The outlet channels (e.g., 462, 464, 466, 468) from the bottom thermal components (e.g., 320-1, 320-2, 320-3, 320-4) form aggregation points and aggregate the fluid flow as it exits to the outlet 460. Once the fluid flows upward from a bottom thermal component 320 to the top thermal component 310, the fluid can travel along the y-direction through a main circulation channel before exiting. The top thermal component 310 may include a separate circulation channel dedicated to the top side, through which the fluid also flows before leaving the thermal management system 400. The channel dimensions at these aggregation points are relatively larger compared to other sections due to the combined flow from both the top thermal component 310 and bottom thermal components (e.g., 320-1, 320-2, 320-3, 320-4).

As illustrated in FIG. 4A, the flow distribution for the bottom thermal component 320 addresses temperature deviations. For example, when an assumed volume of 100 units of fluid enters the thermal management system 400, the fluid flow splits evenly into two fluid pathways, with 35 units directed to each battery subassembly 115 initially. Further allocation directs 12.5 units (or half of the 35 units to that battery module) to the bottom thermal component 320 and another 12.5 units to three top channels. As the fluid circulates across the battery cell 120 surfaces, heat energy is transferred, causing a gradual temperature rise. Battery cells 120 positioned nearer to the inlet 450 can experience cooler temperatures, while battery cells 120 farther away from the inlet 450 can experience higher temperatures, resulting in cell-to-cell temperature variation. To address this, adjustments can be made to the bottom thermal component's channel volume. By increasing the channel volume, additional fluid at cooler temperatures can be supplied to hotter regions in the battery pack 110, compensating for temperature rises experienced at the top side of the battery pack 110. This configuration can help reduce temperature differentials across the battery cells 120 by providing less fluid to a first side of the bottom thermal component 320 and providing more fluid to a second side of the bottom thermal component 320. For example, the bottom thermal component may include a first circulation channel 470 and a second circulation channel 480, in which the first circulation channel 470 has a smaller diameter than the second circulation channel 480. Consequently, the circulation channel configuration in the bottom thermal component 320 can help reduce temperature deviations between battery cells 120 on opposite sides of the thermal management system 400 through variation in cooling path allocation for the bottom thermal component 320.

The circulation flow architecture in each of the top thermal component 310 and bottom thermal components 320 may include local series and/or local parallel configurations. In one or more implementations, each of the top thermal component 310 and bottom thermal components 320 may include a serpentine flow path, a ladder-type flow path or other suitable circulation flow path. The selection between which circulation flow path to apply for the thermal management system 400 can be determined as a function of the heat rejection needed and the effective cooling achievable. Three-dimensional simulations can be beneficial to evaluate gradient objectives or how the battery cells 120 can dissipate heat and may inform the optimal flow path selection.

The layout configuration of the top thermal component 310 and the bottom thermal components 320 can differ based on the specific type of battery pack architecture. In one or more implementations, the bottom thermal component 320 can be incorporated for each battery subassembly 115 such that architectural layout of the bottom thermal components 320 may differ based on the number of battery subassemblies 115 implemented in the battery pack 110 architecture. In one or more other implementations, a single bottom thermal component 320 can be incorporated in one battery pack 110 that spans across a number of battery subassemblies 115.

FIG. 4B illustrates a block diagram of a side view of the thermal management system 400 in accordance with one or more implementations. The side view illustrates how the vertical fluid channels are embedded within the cross members 330, demonstrating the flow path as the fluid moves down, up, and exits through the bottom thermal component 320. In one or more implementations, routing of the inlet 450 and outlet 460 across the battery subassemblies 115 may vary depending on the battery subassembly 115 orientation and the vehicle 100 architecture. In one or more implementations, the battery subassemblies 115 may be stacked laterally from side to side. In one or more other implementations, the battery subassemblies 115 may be stacked longitudinally along the length of the vehicle 100.

To maximize spatial efficiency, the fluid channels are integrated within a y-directional cross member 330 composed of a rigid metal (e.g., extruded aluminum), with a low-profile cross-section width (e.g., about 30 millimeters). This configuration can accommodate the vertical thermal pipes and fittings within the cross member 330, reducing the need for additional fluid routing space.

In one or more implementations, the thermal management system 400 may employ a large top thermal component 310 in combination with individual bottom thermal components 320 for each battery subassembly 115. This arrangement may follow a “waterfall” fluid routing pattern, in which fluid flow passes sequentially between the top thermal component 310 and bottom thermal component 320 and through multiple battery subassemblies 115. The top thermal component 310 may provide thermal management not only for the battery cell 120 array but also for additional components such as the EMM 420 and the HVDB 410 by integrating these elements into the thermal management system 400 fluid loop. The side view of the top thermal component 310 illustrates its interfaces with both the energy volume, which houses the battery subassemblies 115, and the HVDB 410. In one or more implementations, supercooling may not be needed for the HVDB 410 and the EMM 420 components to maintain satisfactory performance and durability. The integration of these components may result in a more efficient and adaptable system, beneficial for high-performance applications, such as DCFC and demanding drive cycles. For lower-cost and lower-performance vehicles, this system configuration allows for simplified or scaled-back cooling solutions. The flexibility to configure and expand cooling capacity based on product requirements is supported through features integrated into the lower part of the cooling design.

In one or more implementations, FIG. 4B illustrates a thermal component arrangement in which each battery subassembly 115 (e.g., battery subassemblies 115-1, 115-2, 115-3, 115-4) is supported by an individual bottom thermal component 320 (e.g., bottom thermal components 320-1, 320-2, 320-3, 320-4). The bottom thermal component 320 may be positioned within the vehicle 100 such that, when installed, the battery pack 110 is located above it, with the top side of the bottom thermal component 320 in contact with the underside of the battery cells 120. The top thermal component 310 may function as the primary cooling component, while the bottom thermal component 320 may be an optional component included in high-performance configurations. The bottom thermal component 320 may incorporate vents and attachment points enabling bolting into the vehicle 100 structure, allowing the battery subassembly 115 assembly to function as a structural shear element. This shear capability may be beneficial in safety load cases such as side-impact collisions, including pole-impact events, by contributing to the distribution of loads across the width of the vehicle 100. In some electric vehicle architectures, where the battery pack 110 enclosure occupies significant underbody volume, the integration of the bottom thermal component 320 into the longitudinal structure of the battery pack 110 may enhance its ability to sustain lateral loads. In other implementations where the bottom thermal component 320 is omitted, a separate shear plate or shield plate may be incorporated to maintain structural performance in the absence of the cooling function.

From a manufacturing perspective, each battery subassembly 115 may be configured with a bottom thermal component 320 at the module assembly stage before integration at the battery pack level. This modular approach can allow for a top thermal component 310 to be added during battery pack assembly. The dual top and bottom thermal component 320 architecture supports configurations where battery packs are assembled with a large thermal component, either as a top thermal component 310 or integrated with a bottom thermal component 320 through blind mating connections. The dual top and bottom thermal component arrangement also allows for various assembly processes, including configurations where battery cells are bonded to the top thermal component 310 before the bottom thermal component 320 is secured. The battery pack architecture can be adaptable to this configuration, facilitating either inverted assembly processes or the incremental addition of cooling features based on specific requirements. Cooling interfaces remain possible in both configurations, enhancing flexibility and system scalability.

The architectural layout between a single bottom thermal component 320 and multiple bottom thermal components (e.g., 320-1, 320-2, 320-3, 320-4) provides different structural integrity in the battery pack 110. With individual bottom thermal components (e.g., 320-1, 320-2, 320-3, 320-4), the cross members 330 oriented in the y-direction can be retained underneath the bottom thermal component 320. This structural arrangement can provide enhanced resistance to bottom strikes (or structural impacts underneath the vehicle 100 undercarriage) by distributing impact forces across supporting cross members 330, reducing deformation or intrusion of the battery pack 110. In one or more other implementations, utilizing a single large bottom thermal component 320 may necessitate the removal of the y-direction cross members 330 beneath the bottom thermal component 320, resulting in impact energy being directly transferred to the bottom thermal component 320, which can increase intrusion due to reduced structural support.

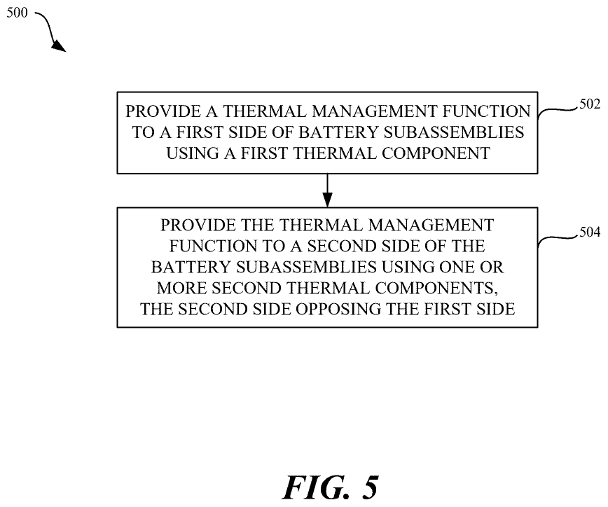

In one or more implementations, the thermal management system 400 includes a venting architecture 490 to facilitate management of thermal runaway events in a manner consistent with structural and thermal protection considerations. The venting architecture 490 may include vents integrated into each of the bottom thermal components 320-1, 320-2, 320-3, 320-4 to facilitate controlled airflow or gas release in designated regions. The top thermal component 310 may function as the primary cooling component and serve as the platform-level cooling component for all configurations. The bottom thermal component 320 may function as an additional cooling component intended for high-performance applications. This arrangement may provide modularity and flexibility within the thermal management system 400 by enabling the addition of a bottom thermal component (e.g., bottom thermal components 320-1, 320-2, 320-3, 320-4) when increased thermal performance is beneficial. FIG. 5 is a flow chart of illustrative operations that may be performed for thermal regulation of batteries using multiple thermal components in accordance with one or more implementations. For explanatory purposes, the process 500 is primarily described herein with reference to the vehicle 100, the dual top and bottom thermal component architecture 200, the top thermal component 310 and the bottom thermal component 320 of FIG. 3, and the thermal system architecture 300 of FIG. 3. However, the process 500 is not limited to the vehicle 100, the thermal system architecture 300, the top thermal component 310 and the bottom thermal component 320 of FIG. 3, the thermal system architecture 300 of FIG. 3, and one or more blocks (or operations) of the process 500 may be performed by one or more other components of other suitable moveable apparatuses, devices, or systems. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

As illustrated in FIG. 5, at block 502, a thermal management system may provide a thermal management function (e.g., cooling or heating) to a first side of a plurality of battery cells using a first thermal component.

At block 504, the thermal management system also may provide the thermal management function to a second side of the plurality of battery cells using one or more second thermal components, in which the second side opposes the first side.

The thermal management system may circulate a fluid through the first thermal component along a first axis and distribute the fluid along a second axis orthogonal to the first axis to each of the one or more second thermal components through a cross member located between respective ones of the one or more second thermal components. The thermal management system also may circulate the fluid through a first circulation channel and a second circulation channel in each of the one or more second thermal components. In some aspects, the first circulation channel has a smaller diameter than the second circulation channel to reduce temperature variations across the battery pack 110.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A thermal management system comprising:
a first thermal component; and
a second thermal component,
wherein the first thermal component is configured to provide a thermal management function to a first side of a plurality of battery subassemblies and the second thermal component is configured to provide the thermal management function to a second side of the plurality of battery subassemblies that opposes the first side.

2. The thermal management system of claim 1, wherein the first thermal component is configured to function as a structural element on the first side of the plurality of battery subassemblies.

3. The thermal management system of claim 1, wherein the first thermal component forms a lid of a battery pack comprising the plurality of battery subassemblies.

4. The thermal management system of claim 1, wherein the first thermal component has a greater thickness than the second thermal component.

5. The thermal management system of claim 1, wherein the first thermal component is mechanically coupled to a thermal insulation layer arranged on a side of the first thermal component, wherein the thermal insulation layer is configured to function as a structural element on the side of the first thermal component to provide structural support for shear loads.

6. The thermal management system of claim 1, wherein one or more of the first thermal component or the second thermal component comprise a thermally conductive material.

7. The thermal management system of claim 1, wherein one or more of the first thermal component or the second thermal component are directly bonded to the plurality of battery subassemblies.

8. The thermal management system of claim 1, wherein at least two battery subassemblies of the plurality of battery subassemblies are directly coupled to separate thermal components at the second side of the at least two battery subassemblies.

9. The thermal management system of claim 1, wherein the thermal management function comprises at least one of cooling or heating.

10. A method, comprising:
providing a thermal management function to a first side of a plurality of battery cells using a first thermal component, wherein the thermal management function comprises at least one of cooling or heating; and
providing the thermal management function to a second side of the plurality of battery cells using one or more second thermal components, the second side opposing the first side.

11. The method of claim 10, further comprising:
circulating a fluid through the first thermal component along a first axis; and
distributing the fluid along a second axis orthogonal to the first axis to each of the one or more second thermal components through a cross member located between respective ones of the one or more second thermal components.

12. The method of claim 10, further comprising circulating a fluid through a first circulation channel and a second circulation channel in each of the one or more second thermal components, wherein the first circulation channel has a smaller diameter than the second circulation channel.

13. A vehicle, comprising:
a first thermal component configured to provide a thermal management function to a first side of a plurality of battery subassemblies; and
a plurality of second thermal components, each of the plurality of second thermal components configured to provide the thermal management function to a second side of the plurality of battery subassemblies that opposes the first side,
wherein the first thermal component circulates a fluid through the first thermal component along a first axis and distributes the fluid along a second axis orthogonal to the first axis to each of the plurality of second thermal components through a cross member located between respective ones of the plurality of second thermal components.

14. The vehicle of claim 13, wherein each of the plurality of second thermal components comprises a first circulation channel and a second circulation channel to circulate the fluid through the first circulation channel and the second circulation channel, and wherein the first circulation channel has a smaller diameter than the second circulation channel.

15. The vehicle of claim 13, further comprising a high-voltage distribution box (HVDB) and an energy management module (EMM), wherein the first thermal component is thermally coupled to the plurality of battery subassemblies, the HVDB and the EMM to provide the thermal management function to at least one of the plurality of battery subassemblies, the HVDB or the EMM.

16. The vehicle of claim 13, wherein each of the plurality of battery subassemblies is thermally coupled to a respective one of the plurality of second thermal components.

17. The vehicle of claim 13, wherein the first thermal component is configured to function as a structural element on the first side of the plurality of battery subassemblies.

18. The vehicle of claim 13, wherein the first thermal component forms a lid of a battery pack configured as a floor of the vehicle.

19. The vehicle of claim 13, wherein the first thermal component has a greater thickness than each of the plurality of second thermal components.

20. The vehicle of claim 13, wherein the thermal management function comprises at least one of cooling or heating.
